(19) United States
(12) Patent Application Publication
(10) Pub. No.: US 2024/0371098 A1
(43) Pub. Date: Nov. 7, 2024

(54) Three-Dimensional Wound Reconstruction using Images and Depth Maps

(71) Applicant: Fabri Sciences Inc., Edmonton (CA)

(72) Inventors: Connor William Lipkewich Povoledo, Edmonton AB (CA); Jacob Lee Damant, Edmonton AB (CA)

(21) Appl. No.: 18/312,407

(22) Filed: May 4, 2023

(51) Int. Cl. G06T 17/20; G06T 3/40; G06T 5/00; G06T 7/10; G06V 10/25; G06V 10/56; G06V 10/74

(52) U.S. Cl. CPC G06T 17/20; G06T 3/40; G06T 5/70; G06T 7/10; G06V 10/25; G06V 10/56; G06V 10/761; G06T 2207/10024; G06T 2207/10028; G06T 2207/20132

(57) ABSTRACT

Example embodiments relate to a three-dimensional wound reconstruction using images and depth maps. One example method includes receiving, by a computing device, an image that includes a wound. The method also includes receiving, by the computing device, a depth map that includes the wound. Additionally, the method includes identifying, by the computing device applying a machine-learned model for wound identification, a region of the image that corresponds to the wound. Further, the method includes aligning, by the computing device, the image with the depth map. In addition, the method includes determining, by the computing device based on the identified region of the image that corresponds to the wound, a region of the depth map that corresponds to the wound. Yet further, the method includes generating, by the computing device, a three-dimensional reconstruction of the wound based on the region of the depth map that corresponds to the wound.

### BACKGROUND

Medical images of various modalities are frequently used in diagnosing and/or treating medical conditions (e.g., diseases) experienced by patients. For example, two-dimensional color images captured by cameras may be used by medical professionals in assessing the extent of a patient's injuries. While such images provide useful information, they do not provide a complete picture of the patient's condition for a number of reasons. For example, such images are only captured from a single perspective and, therefore, may inadvertently fail to completely capture important features of a patient's injuries. Further, if no frame of reference is provided in the captured image, it may be difficult or impossible to determine the scale of one or more objects in the image (e.g., it may be difficult to determine whether a laceration is a few millimeters in length or a few centimeters in length).

Alternative imaging modalities besides simple two-dimensional color images can also be used in medical diagnosis and treatment. For example, x-ray imaging or magnetic resonance imaging (MRI) can also be used. While such alternative modalities may augment the capabilities of a standard two-dimensional color images, it may be difficult and/or prohibitively expensive to combine the two modalities into a single useful metric or representation.

### SUMMARY

The specification and drawings disclose embodiments that relate to three-dimensional wound reconstruction using images and depth maps.

In a first aspect, the disclosure describes a method. The method includes receiving, by a computing device, an image that includes a wound. The method also includes receiving, by the computing device, a depth map that includes the wound. Additionally, the method includes identifying, by the computing device applying a machine-learned model for wound identification, a region of the image that corresponds to the wound. Further, the method includes aligning, by the computing device, the image with the depth map. In addition, the method includes determining, by the computing device based on the identified region of the image that corresponds to the wound, a region of the depth map that corresponds to the wound. Yet further, the method includes generating, by the computing device, a three-dimensional reconstruction of the wound based on the region of the depth map that corresponds to the wound. Still further, the method includes applying, by the computing device, one or more colorations to the three-dimensional reconstruction of the wound based on one or more colorations in the identified region of the image that corresponds to the wound.

In a second aspect, the disclosure describes a non-transitory, computer-readable medium having instructions stored thereon. The instructions, when executed by a processor, cause the processor to receive an image that includes a wound. The instructions also cause the processor to receive a depth map that includes the wound. In addition, the instructions cause the processor to identify, by applying a machine-learned model for wound identification, a region of the image that corresponds to the wound. Further, the instructions cause the processor to align the image with the depth map. Additionally, the instructions case the processor to determine, based on the identified region of the image that corresponds to the wound, a region of the depth map that corresponds to the wound. Still further, the instructions cause the processor to generate a three-dimensional reconstruction of the wound based on the region of the depth map that corresponds to the wound. Even further, the instructions cause the processor to apply one or more colorations to the three-dimensional reconstruction of the wound based on one or more colorations in the identified region of the image that corresponds to the wound.

In a third aspect, the disclosure describes a device. The device includes a camera configured to capture an image. The device also includes a depth sensor configured to capture a depth map. Additionally, the device includes a computing device. The computing device is configured to receive the image. The image includes a wound. The computing device is also configured to receive the depth map. The depth map includes the wound. Additionally, the computing device is configured to identify, by applying a machine-learned model for wound identification, a region of the image that corresponds to the wound. Further, the computing device is configured to align the image with the depth map. In addition, the computing device is configured to determine, based on the identified region of the image that corresponds to the wound, a region of the depth map that corresponds to the wound. Still further, the computing device is configured to generate a three-dimensional reconstruction of the wound based on the region of the depth map that corresponds to the wound. Yet further, the computing device is configured to apply one or more colorations to the three-dimensional reconstruction of the wound based on one or more colorations in the identified region of the image that corresponds to the wound.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a block diagram of a device, according to example embodiments.

FIG. 2A is an illustration of a method for training a machine-learned model, according to example embodiments.

FIG. 2B is an illustration of a method of making a prediction using a machine-learned model, according to example embodiments.

FIG. 3A is an illustration of a device capturing an image and a depth map of a wound, according to example embodiments.

FIG. 3B is an illustration of an identification of a region of an image that corresponds to a wound, according to example embodiments.

FIG. 3C is an illustration of an alignment of an image and a depth map, according to example embodiments.

FIG. 3D is an illustration of a determination of a region of a depth map that corresponds to a wound, according to example embodiments.

FIG. 3E is an illustration of a generation of a three-dimensional reconstruction of a wound and an application of one or more colorations to the three-dimensional reconstruction, according to example embodiments.

FIG. 4A is an illustration of a generation of a wound mask, according to example embodiments.

FIG. 4B is an illustration of an application of a wound mask to a depth map, according to example embodiments.

FIG. 4C is an illustration of a displaying of a colorized three-dimensional reconstruction of a wound, according to example embodiments.

FIG. 5A is an illustration of a generated mesh, according to example embodiments.

FIG. 5B is an illustration of a calculation of a wound volume, according to example embodiments.

FIG. 6A is an illustration of a generation of a three-dimensional reconstruction of a healed wound, according to example embodiments.

FIG. 6B is an illustration of a displaying of a wound healing, according to example embodiments.

FIG. 7 is a flowchart illustration of a method, according to example embodiments.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the figures should not be viewed as limiting. It should be understood that other embodiments might include more or less of each element shown in a given figure. In addition, some of the illustrated elements may be combined or omitted. Similarly, an example embodiment may include elements that are not illustrated in the figures.

The term “image” is used throughout this disclosure. The term “image” is meant to describe a series of color values (e.g., stored within one or more arrays or matrices) that correspond to a series of pixels. An “image” of an environment (e.g., including a limb and/or a wound) may have been captured by a camera (e.g., may have been detected by an image sensor of a camera that is sensitive to visible light spectra). Further, an “image” may be stored as a file in a memory (e.g., a non-volatile or volatile memory) within a computing device. Likewise, an “image” may be stored in a variety of file formats (e.g., .JPG, PNG, .RAW, etc.). Additionally, an “image” may be isolated from what was originally a series of images. For example, a video stream may be captured of a surrounding environment using a camera (e.g., at 16 frames per second (fps), 24 fps, 30 fps, 60 fps, 64 fps, etc.), and an “image” may represent a single frame extracted from the video stream. In some cases, an “image” may also have one or more associated pieces of metadata (e.g., a timestamp/datestamp; a location of image capture; optical specifications of the camera used to capture the image, such as focal length of one or more lenses, exposure time, aperture, image sensor sensitivity, make/model of the camera, etc.; or an orientation within three-dimensional space of the camera used to capture the image, which may be measured by an associated accelerometer or global positioning system (GPS) sensor, for example).

The term “depth map” is also used throughout this disclosure. The term “depth map” is meant to describe a series of depth values (e.g., stored within one or more arrays or matrices) that correspond to a series of pixels. A “depth map” of an environment (e.g., including a limb and/or a wound) may have been captured by a depth sensor (e.g., the TRUEDEPTH sensor of an APPLE IPHONE). For example, an infrared projector may project an array of infrared signals into the environment and an image sensor that is sensitive to infrared light spectra may detect reflections of the infrared signals. Further, in some cases, the depth sensor may include a controller that outputs depth values or disparity values detected by each infrared-sensitive pixel of the infrared-sensitive image sensor. These depth values may be determined based on time-of-flight between an emission time of each of the infrared signals and a detection time of each of the infrared signals. Like an “image,” a “depth map” may be stored may be stored as a file in a memory (e.g., a non-volatile or volatile memory) within a computing device. Likewise, a “depth map” may be stored in a variety of file formats (e.g., .JPG, PNG, .RAW, etc.). Unlike an “image,” however, in a “depth map,” the color of each pixel within the file may represent relative depth. For example, a “depth map” may be a grayscale .JPG file where the darker a pixel is within the .JPG file, the greater the relative depth at that pixel (e.g., using 32-bit depth values). Also like the “image,” a “depth map” may be isolated from what was originally a series of depth maps. For example, a video stream may be captured of a surrounding environment using a depth sensor (e.g., at 16 fps, 24 fps, 30 fps, 60 fps, 64 fps, the same fps as a corresponding camera capturing images, a different fps than a corresponding camera capturing images, etc.), and a “depth map” may represent a single frame extracted from the video stream. Still further, a “depth map” may also have one or more associated pieces of metadata (e.g., a timestamp/datestamp; a location of depth map capture; optical specifications of the depth sensor used to capture the depth map, such as focal length of one or more lenses, exposure time, aperture, image sensor sensitivity, make/model of the depth sensor, etc.; or an orientation within three-dimensional space of the depth sensor used to capture the depth map, which may be measured by an associated accelerometer or GPS sensor, for example).

### I. Overview

Described herein are techniques for generating a three-dimensional reconstruction of a wound using images and depth maps. For example, a mobile computing device (e.g., a smart phone) may include a camera (e.g., a front-facing camera) that is capable of capturing an image of a surrounding scene and a depth sensor that is capable of capturing a depth map of a surrounding scene. Using both the captured image and the captured depth map, a computing device may be configured to generate a reconstruction of the wound that can be viewed (e.g., on a display) and/or used to calculate additional characteristics that could be used for diagnosis or treatment (e.g., a wound depth, a wound surface area, or a wound volume). The techniques herein may provide a cost-effective and computationally inexpensive process for generating clinically useful three-dimensional reconstructions. Further, because the techniques described herein may be employed using a mobile computing device, a three-dimensional reconstruction may be generated without requiring a patient to be in a hospital or medical clinic for imaging.

In some embodiments, a method of generating of three-dimensional reconstruction may begin by capturing an image of a wound. For example, a front-facing camera of a smart phone (e.g., the FACETIME camera of an IPHONE) may be used to capture an image of the wound. The image may be stored (e.g., temporarily) in a memory (e.g., a random-access memory (RAM) of the smart phone or a non-volatile memory, such as a hard drive). In various embodiments, the image may be stored in various formats. For example, the image may be stored (e.g., as a raster image or as a vector image) as a JPEG file, a .PNG file, a .TIFF file, a .BMP file, a .GIF file, a .PDF file, a .RAW file, a .EPS file, etc. In some cases (e.g., if the image is going to be stored long-term), the image may be compressed using one or more compression techniques. In some embodiments, the image may be a color image (e.g., a red-green-blue (RGB) image, an HSV image, an HSL image, a YCbCr image, a CMYK image, etc.), a grayscale image, or a black-and-white image.

In addition to capturing the image of the wound, a depth map of the wound may also be captured. For example, a depth map of the wound may be captured by a depth sensor of a smart phone (e.g., the TRUEDEPTH sensor of an APPLE IPHONE). In some embodiments, the depth sensor may capture the depth map of the wound substantially simultaneously with (e.g., within 1 s of, within 100 ms of, within 10 ms of, within 1 ms of, within 100 μs of, within 10 μs of, or within 1 μs of) the camera capturing the image of the wound. Additionally or alternatively, the camera capturing the wound and the depth sensor capturing the depth map may be located relatively close to one another, have a similar perspective to one another, and/or have overlapping fields of view. In this way, an image of the wound and a corresponding depth map of the wound can be captured that can be readily combined (e.g., without concern for differences in timing and/or subject visibility between the image and the depth map).

Upon capturing the image of the wound and the depth map of the wound, a computing device (e.g., a processor, such as the processor of a smart phone, executing instructions stored on a non-transitory, computer-readable medium) may perform a process by executing an image processing algorithm using the image and the depth map. The process may be performed to extract and combine features from both the image and the depth map in order to generate a three-dimensional reconstruction of the wound.

First, for example, the process may include performing object detection within the image in order to identify the location of the wound within the image. Performing the object detection may include applying a machine-learned model (e.g., a classifier) that is trained (e.g., using labeled or unlabeled training data) to identify regions within images that represent wounds. In some embodiments, the machine-learned model that is applied may be trained to identify specific types of wounds (e.g., lacerations) associated with the captured image. Alternatively, the machine-learned model may be trained to identify wounds, generally. If no wound is successfully identified within the image, an error may be output and/or another scan may be performed.

Upon identifying the wound within the image, the process may next include aligning the image with the depth map. This may include rotating one or both of the image and/or depth map, for example. In addition to aligning the image with the depth map, one or both of the image and/or depth map may be cropped and/or downscaled in resolution. These techniques may be performed such that portions of the image can be readily interrelated to portions of the depth map. For example, after aligning the image with the depth map, the computing device may determine a region within the depth map that represents the wound. This determination may be made by equating the region of the image that includes the wound (e.g., as identified using the machine-learned model) to a region of the depth map based on the alignment of the image and the depth map. For example, if, after alignment, cropping, and/or downscaling, the image and the depth map have the same resolution and correspond to the same perspective of a subject (e.g., a person who has a wound), the x-y coordinates of pixels that correspond to the wound in the image can be used as x-y coordinates for pixels within the depth map to identify a portion of the depth map that corresponds to the wound.

Once portions of the depth map and the image that correspond to the wound have been determined, information from these portions can be merged to generate a three-dimensional reconstruction of the wound. For example, the portion of the depth map that corresponds to the wound could be used to generate a three-dimensional reconstruction (e.g., based on the depths for each pixel in the depth map). Once the three-dimensional reconstruction is built, the reconstruction could be colorized using information from the portion of the image corresponding to the wound. For example, if the wound is captured in RGB colorspace, RGB values from the pixels in the image that correspond to the wound could be applied to corresponding portions of the reconstruction. In some embodiments, discrete points within the three-dimensional reconstruction (e.g., colorized points) may be meshed together to form a surface. Further, portions of the mesh (e.g., portions of the faces of the mesh that form the surface) may be determined by interpolation (e.g., the depths at various points on the faces or the color at various points on the faces). The surface/mesh may be displayed by the computing device (e.g., on a display). For example, the surface may be displayed to a medical professional (e.g., a nurse or a physician) or a patient on a display. Further, the medical professional or patient may interact with a user interface (e.g., a touchscreen) to rotate the surface such that it can be viewed from different angles. Additionally or alternatively, the three-dimensional reconstruction and/or the mesh may be stored (e.g., within a memory, such as a cloud storage) for future access and/or analysis. Still further, in some embodiments, the three-dimensional reconstruction may be used to calculate one or more quantities about the wound. For example, the three-dimensional reconstruction may be used to calculate the surface area, volume, and/or depth of the wound. Yet further, in some embodiments, after generating the three-dimensional reconstruction of the wound, the three-dimensional reconstruction of the wound may be used to generate a three-dimensional reconstruction of the body part (e.g., limb, face, head, chest, etc.) while the wound heals or after the wound fully heals (e.g., using inpainting and/or interpolation based on the coloration of portions of the body part that surround the wound region). The three-dimensional reconstruction of the fully healed wound may be displayed to a user (e.g., alongside the three-dimensional reconstruction of the wound).

Embodiments described herein provide technical improvements to computer technology and other technologies, such as healthcare technology (e.g., wound diagnostics and treatment). Alternative techniques may include a healthcare professional (e.g., physicians, nurses, clinicians, etc.) meeting with a patient, in person, to measure various characteristics of a patient's wound (e.g., width, length, depth, or color). These characteristics may be recorded and then charted to determine wound severity and/or to prescribe treatment. Such techniques, however, are prone to human inaccuracy and measure relatively small amounts of information. Some of the techniques described herein, however, provide an entire surface topology of a wound (rather than merely simple descriptors like width, length, or depth). Additionally, the coloration of a wound can be determined based on color data captured by a camera (rather than simply estimated by a healthcare professional). Additionally, the generated three-dimensional wound reconstruction can be transmitted (e.g., over the public internet). In this way, an entire reconstruction (rather than merely simple descriptors or one or two images of a wound) can be transmitted for remote analysis. In an emergency situation (e.g., when a patient has recently suffered a severe wound), the ability to transmit a complete three-dimensional wound reconstruction to a medical professional for review/analysis can enhance the speed with which that wound can be diagnosed/treated, thereby improving patient outcomes. Further, by not requiring physical contact as part of the measurement (e.g., by using a camera and a depth sensor instead of a physical measurement like with a ruler), an accurate, contactless measurement can be taken using some of the techniques disclosed herein, which may prevent the spread of disease or contamination of the wound which can lead to further complications.

In addition to providing improvements over in-person measurement of patient wounds, example embodiments also represent improvements over other alternative techniques, as well. One additional alternative technique involves two-dimensional imaging technology that measures wound characteristics (e.g., length) relative to a physical reference (e.g., a single-use sticker that indicates units of measure and is placed on or near the patient) within an image frame. Example embodiments herein may provide improvements over such an approach in that example embodiments do not require the use of a physical reference, which may reduce environmental impact and allow for wound analysis even when such physical references are not on-hand. Further, example embodiments herein may not suffer from the inaccuracies that inherently result from trying to map a three-dimensional object (e.g., a wound) using a two-dimensional physical reference (e.g., a wound may be longer than it appears relative to the two-dimensional physical reference if the wound is on a curved surface, such as a wrist or arm).

Still other additional alternative techniques (e.g., photogrammetry) involve capturing large numbers of reference images (e.g., RGB images) from different locations at different points in time and then estimating the location of certain objects within the image by triangulation (e.g., by matching the same object present in different images and comparing the relative location of those objects). Unlike such triangulation techniques, the measurements carried out using the techniques described herein may have improved accuracy and take less time. As a first point, some of the techniques described herein may only capture a single image and a single depth map over a relatively short time span (e.g., substantially simultaneously), unlike triangulation techniques that may capture a series of images from different perspectives over a period of time. Hence, not only do some example embodiments inherently reduce the amount of time needed to capture the data used to perform the measurements, but example embodiments may also correspondingly enhance accuracy as a result of reducing or eliminating changes in the subject (e.g., the patient or the wound) due to time evolution. Still further, some of the techniques described herein may only involve capturing and analyzing two sets of data (an image and a depth map). In the case of photogrammetry, more than two images may be captured, stored, and analyzed. In order to perform photogrammetric calculations, nominal measurements and/or reference points may be incorporated into and/or associated with the multiple images. This may result in additional consumption of computing resources (e.g., storage resources, such as hard drive space or volatile memory space, and/or processing power). While some of these issues might be lessened using stereophotogrammetry, such techniques cannot be readily performed using a mobile computing device with high precision (e.g., because the physical separation between cameras on a mobile computing device might be too small to perform accurate parallax measurements).

Other possible advantages include the software providing advice to a patient (e.g., using information from one or more treatment databases based on information identified about the patient's wound) in an emergency situations when a medical professional is not available (e.g., how to disinfect and dress the wound). Additionally or alternatively, embodiments described herein can be used for military field medicine or other scenarios (e.g., traveling in remote locations) where a doctor might not be readily available.

### II. Example Systems

The following description and accompanying drawings will elucidate features of various example embodiments. The embodiments provided are by way of example, and are not intended to be limiting. As such, the dimensions of the drawings are not necessarily to scale.

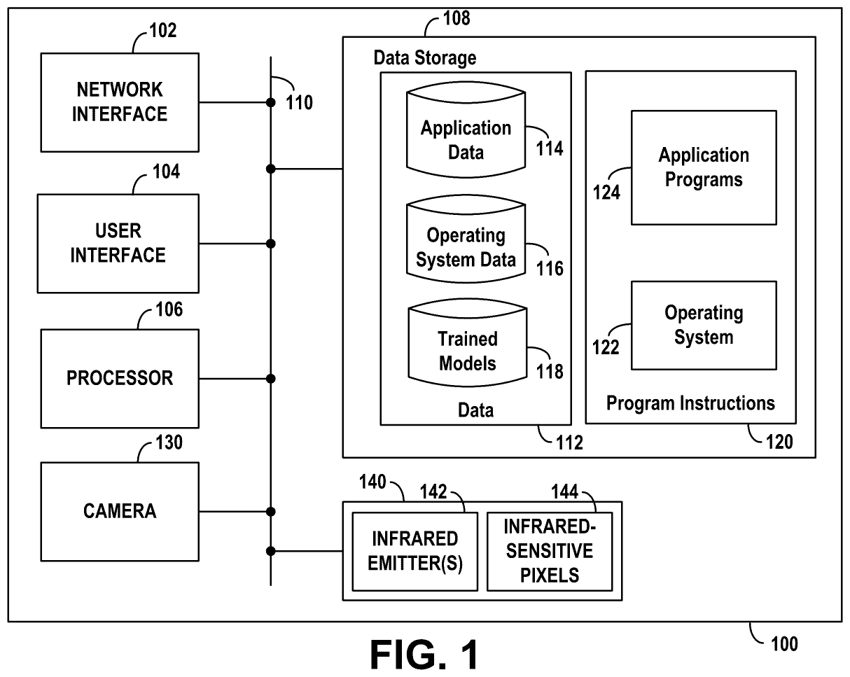

FIG. 1 is a block diagram of a device 100, according to example embodiments. In some embodiments, the device 100 may be a mobile computing device (e.g., a smartphone), a desktop computing device, a laptop computing device, a tablet computing device, or some other type of computing device. As shown in FIG. 1, the device 100 may include a network interface 102, a user interface 104, a processor 106, a data storage 108, a camera 130, and a depth sensor 140, all of which may be communicatively linked together by a system bus, network, or other connection mechanism 110.

The network interface 102 may allow the device 100 to communicate with other devices and/or across a network. Thus, the network interface 102 may facilitate circuit-switched and/or packet-switched communication, such as plain old telephone service (POTS) communication and/or internet protocol (IP) or other packetized communication. For instance, the network interface 102 may include a chipset and/or an antenna arranged for wireless communication with a radio access network or an access point. In some embodiments, the network interface 102 may include a wireline interface (e.g., Ethernet, Universal Serial Bus (USB), etc.). Additionally or alternatively, the network interface 102 may include a wireless interface (e.g., WIFI; BLUETOOTH; GPS; wide-area wireless interface, such as WiMAX or 3GPP Long-Term Evolution (LTE); etc.).

The user interface 104 may allow the device 100 to receive inputs (e.g., from a user) and/or to provide outputs (e.g., to the user). Thus, the user interface 104 may include input components (e.g., peripherals such as keypads, keyboards, touch-sensitive panels, computer mice, trackballs, joysticks, microphones, etc.). The user interface 104 may also include one or more output components (e.g., a display, which, for example, may be combined with a touch-sensitive panel). The display may include one or more cathode ray tube (CRT) displays, liquid crystal displays (LCDs), light-emitting diode (LED) displays, and/or organic LED (OLED) displays. In some embodiments, the user interface 104 may also be configured to generate audible output(s) (e.g., via a speaker, speaker jack, audio output port, audio output device, earphones, etc.). The user interface 104 may further be configured to receive and/or capture audible utterance(s), noise(s), and/or signal(s) by way of a microphone and/or other similar devices.

In some embodiments, the user interface 104 may include a display that serves as a viewfinder for still camera functions, video camera functions, and/or depth sensor functions supported by the device 100. Additionally, the user interface 104 may include one or more buttons, switches, knobs, and/or dials that facilitate the configuration and focusing of the camera 130 and/or the depth sensor 140 for capturing images and/or depth maps. It various embodiments, some or all of the buttons, switches, knobs, and/or dials may be implemented by way of a touch-sensitive panel.

The processor 106 may include one or more general purpose processors (e.g., microprocessors) and/or one or more special purpose processors (e.g., digital signal processors (DSPs), graphics processing units (GPUs), tensor processing units (TPUs), floating point units (FPUs), network processors, or application-specific integrated circuits (ASICs)). In some embodiments, special purpose processors may be capable of image processing, image alignment, and merging images, among other possibilities.

The data storage 108 may include one or more volatile and/or non-volatile storage components (e.g., magnetic, optical, flash, or organic storage) and may be integrated, in whole or in part, with the processor 106. In some embodiments, the data storage 108 may include removable and/or integrated memory components.

The processor 106 may execute program instructions 120 (e.g., compiled or non-compiled program logic and/or machine code) stored in the data storage 108 to carry out the various functions described herein. As such, the data storage 108 may include a non-transitory, computer-readable medium, having stored thereon program instructions that, upon execution by the device 100, cause the device 100 to carry out any of the methods, processes, or operations disclosed in this specification and/or the accompanying drawings. The execution of the program instructions 120 by the processor 106 may result in the processor 106 retrieving, storing, and/or using data 112.

For example, the program instructions 120 may include an operating system 122 (e.g., an operating system kernel, device driver(s), and/or other modules) and one or more application programs 124 (e.g., camera functions, depth sensor functions, address book, email, web browsing, social networking, audio-to-text functions, text translation functions, and/or gaming applications) installed on the device 100. The operating system 122 may include iOS or ANDROID, for example. Similarly, the data 112 may include application data 114, operating system data 116, and/or one or more trained machine-learning models 118. Operating system data 116 may be accessible primarily to operating system 122 and application data 114 and the one or more trained machine-learning models 118 may be accessible primarily to one or more of the application programs 124. The application data 114 may be arranged in a file system that is visible to or hidden from a user of the device 100.

Application programs 124 may communicate with the operating system 122 through one or more application programming interfaces (APIs). These APIs may facilitate, for instance, application programs 124 reading and/or writing application data 114 and/or a trained machine-learning model 118, transmitting or receiving information via the network interface 102, receiving and/or displaying information on the user interface 104, etc.

In some embodiments, application programs 124 may be referred to as “apps” for short (e.g., in embodiments where the application programs 124 are mobile applications and the device 100 is a mobile computing device). Additionally, application programs 124 may be downloadable to the device 100 through one or more online application stores or application markets. However, application programs can also be installed on the device 100 in other ways, such as via a web browser or through a physical interface (e.g., a USB port) on the device 100.

The camera 130 may include various components in various embodiments. In some embodiments, for example, the camera 130 may include an aperture, a shutter, a recording medium (e.g., photographic film and/or an image sensor), one or more lenses, a shutter button, and/or visible-light projectors (e.g., a flash illuminator). The camera 130 may include components configured for capturing of images in the visible-light spectrum (e.g., electromagnetic radiation having a wavelength between 380-700 nanometers). The camera 130 may be controlled, at least in part, by software executed by the processor 106. In some embodiments described herein, the camera 130 may be used to capture one or more images of a wound or a limb (e.g., a wound on a patient's limb). Further, in some embodiments, the camera 130 may be a front-facing “selfie” camera of an APPLE IPHONE.

As illustrated in FIG. 1, the depth sensor 140 may include one or more infrared emitter(s) 142 (e.g., an array of infrared emitters) and infrared-sensitive pixels 144 (e.g., an array of infrared-sensitive pixels). For example, the depth sensor 140 may include a TRUEDEPTH sensor (sometimes referred to as a TRUEDEPTH camera or a FACEID scanner) of an APPLE IPHONE. The infrared emitter(s) 142 may include an infrared flash illuminator and/or one or more LEDs configured to emit light signals (e.g., an array of light signals) within the infrared spectrum (e.g., within the near infrared spectrum between 800 nm and 1.3 μm) into a surrounding environment. The infrared-sensitive pixels 144 may include one or more photodetectors configured to detect light (e.g., to produce an electrical signal based on a received photonic signal) within the infrared spectrum (e.g., configured to detect reflections of the array of infrared signals from objects in the surrounding environment). In some embodiments, the infrared-sensitive pixels 144 may be sensitive to a relatively narrow range of wavelengths (e.g., to reduce noise) that includes one or more wavelengths emitted by the infrared emitter(s) 142. Additionally, though not illustrated in FIG. 1, the depth sensor 140 may include a controller configured to determine depth based on the infrared signals detected by the infrared-sensitive pixels 144. In other embodiments, raw data related to depth may be transmitted directly from the photodetectors to a downstream processor (e.g., the processor 106 shown in FIG. 1). In some embodiments described herein, the depth sensor 140 may be used to capture one or more depth maps of a wound or a limb (e.g., a wound on a patient's limb).

### III. Example Processes

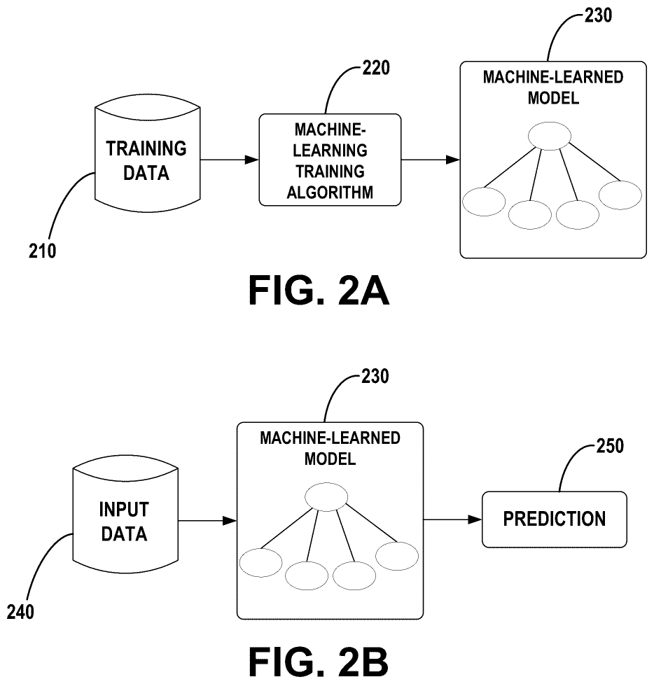

FIG. 2A illustrates a method of training a machine-learned model 230 (e.g., an artificial neural network), according to example embodiments. The method of FIG. 2A may be performed by a device (e.g., the device 100 illustrated in FIG. 1), in some embodiments. As illustrated, the machine-learned model 230 may be trained using a machine-learning training algorithm 220 based on training data 210 (e.g., based on patterns within the training data 210). While only one machine-learned model 230 is illustrated in FIGS. 2A and 2B, it is understood that multiple machine-learned models could be trained simultaneously and/or sequentially and used to perform the predictions described herein. Ultimately, a prediction 250 may be made using the trained machine-learned model 230. For example, various machine-learned models 230 described herein may be used to identify a region of an image that corresponds to a wound, to generate a wound mask for an image based on an identified region, to identify a region of an image that corresponds to a limb (e.g., a limb associated with a wound), to perform inpainting on one or more regions of an image or a depth map, and/or to generate an image corresponding to a limb with a healed wound. Various machine-learned models 230 may be used to perform the tasks above based on input data 240 (e.g., input images, input depth maps, etc.).

The machine-learned model 230 may include, but is not limited to: an artificial neural network (e.g., a convolutional neural network (CNN), a generative adversarial network (GAN), a recurrent neural network, a Bayesian network, a hidden Markov model, a Markov decision process, a logistic regression function, a suitable statistical machine-learning algorithm, and/or a heuristic machine-learning system), a support vector machine, a regression tree, an ensemble of regression trees (also referred to as a regression forest), a decision tree, an ensemble of decision trees (also referred to as a decision forest), or some other machine-learning model architecture or combination of architectures. The machine-learning training algorithm 220 may involve supervised learning, semi-supervised learning, reinforcement learning, and/or unsupervised learning. Similarly, the training data 210 may include labeled training data and/or unlabeled training data .

The training data 210 may include images of wounds, images of limbs (both injured and uninjured), depth maps of wounds, depth maps of limbs (both injured and uninjured), etc. In some embodiments, synthetic training data may be used (e.g., synthetic depth maps of healed limbs and/or synthetic depth maps generated by applying one or more augmentation generators to synthetic data sets or clinical data sets). Using the training data 210, the machine-learning training algorithm 220 may attempt to make a prediction. If the predicted outcome for the input piece of training data 210 matches the label ascribed to the training data 210, this may reinforce the machine-learned model 230 being developed by the machine-learning training algorithm 220. If the predicted outcome for the input piece of training data 210 does not match the label ascribed to the training data 210, the machine-learned model 230 being developed by the machine-learning training algorithm 220 may be modified to accommodate the difference (e.g., the weight of a given factor within the artificial neural network of the machine-learned model 230 may be adjusted). Additionally or alternatively, in some embodiments, the machine-learning training algorithm 220 may enforce additional rules during the training of the machine-learned model 230 (e.g., by setting and/or adjusting one or more hyperparameters).

In various embodiments described herein, various types of machine-learned models may be used. For example, one or more object-detection machine-learned models may be trained and used. The object-detection machine-learned models may include and/or be similar to YOLO architectures. In some embodiments, the object-detection machine-learned models may include one or more neural networks (e.g., CNNs) that can be used to detect a wound within an image, a wound within a depth map, a limb within an image, or a limb within a depth map.

Additionally or alternatively, one or more segmentation machine-learned models may be trained and used. The segmentation machine-learned models may include and/or be similar to the DeepLabsV3+ architecture. In some embodiments, the segmentation machine-learned models may be usable to create a mask for an image or a depth map. The mask may highlight regions of the image or the depth map that correspond to a wound and/or regions of the image or the depth map that correspond to a limb. For example, the regions (e.g., within the image or within the depth map) that correspond to the target object (e.g., the wound) may be given a first value (e.g., an integer value of 255) whereas regions that do not correspond to the target object (e.g., the wound) may be given a second value (e.g., an integer value of 0). Other values (e.g., an RGB value of [255, 255, 255] vs. an RGB value of [0,0,0]) are also possible and are contemplated herein.

Still further, one or more inpainting machine-learned models may be trained and used. The inpainting machine-learned models may include gated convolution. The inpainting machine-learned models may include one or more GANs usable to determine interior regions of a masked portion of an image or a depth map. For example, the inpainting machine-learned models described herein may be usable to determine how a healed wound would appear (e.g., within an image or within a depth map), such as how a healed wound would appear on a limb.

The machine-learned models described herein may be built in TENSORFLOW and then converted to COREML. By converting the machine-learned models to COREML, the machine-learned models may consume fewer computing resources when executed on a mobile computing device (e.g., when executed by a processor of an APPLE IPHONE executing a mobile app). Alternatively, the machine-learned models described herein may be built natively in COREML. Additionally or alternatively, the machine-learned models described herein may be built in TENSORFLOW and then converted to TFLITE.

Once the machine-learned model 230 is trained by the machine-learning training algorithm 220 (e.g., using the method of FIG. 2A), the machine-learned model 230 may be used to make one or more predictions. For example, a device (e.g., the device 100 illustrated and described with reference to FIG. 1), may make a prediction 250 using the machine-learned model 230 based on input data 240, as illustrated in FIG. 2B.

As illustrated in FIG. 2B, the machine-learned model 230 can receive input data 240 and generate and output one or more predictions 250 about input data 240. For example, in some embodiments described herein, the input data 240 may include images of wounds, images of limbs, depth maps of wounds, depth maps of limbs, etc. The machine-learned model 230 (e.g., an artificial neural network) may take these images of wounds, images of limbs, depth maps of wounds, and/or depth maps of limbs and produce the prediction 250 based on this input data 240. The prediction 250 may include a three-dimensional reconstruction of a wound (e.g., a colorized three-dimensional reconstruction of a wound), a three-dimensional reconstruction of a healed wound (e.g., a colorized three-dimensional reconstruction of a healed wound), an image of a wound, an image of healed wound, a wound depth, a wound volume, a wound surface area, a would color, etc. For example, when an image of a wound has been provided in the input data 240, the machine-learned model 230 may generate a three-dimensional reconstruction of the wound (e.g., based on weights for each factor provided in the input data 240 using an artificial neural network of the machine-learned model 230) that can be stored or displayed.

While the same device (e.g., the device 100 shown and described with reference to FIG. 1) may be used to both train the machine-learned model 230 (e.g., as illustrated in FIG. 2A) and make use of the machine-learned model 230 to make a prediction 250 (e.g., as illustrated in FIG. 2B), it is understood that this need not be the case. In some embodiments, for example, a computing device may execute the machine-learning training algorithm 220 to train the machine-learned model 230 and may then transmit the machine-learned model 230 to another computing device for use in making one or more predictions 250. In this context of this disclosure, for example, a computing device may be used to initially train the machine-learned model 230 and then this machine-learned model 230 could be stored for later use. For example, the machine-learned model 230 could be trained and then packaged with a wound detection and analysis application (e.g., a mobile wound detection and analysis app) and distributed to one or more computing devices (e.g., a mobile computing device, such as the device 100 of FIG. 1) as a part of the wound detection and analysis application. Then, the device 100 that receives the wound detection and analysis application may simply make use of the machine-learned model 230 without having to train it.

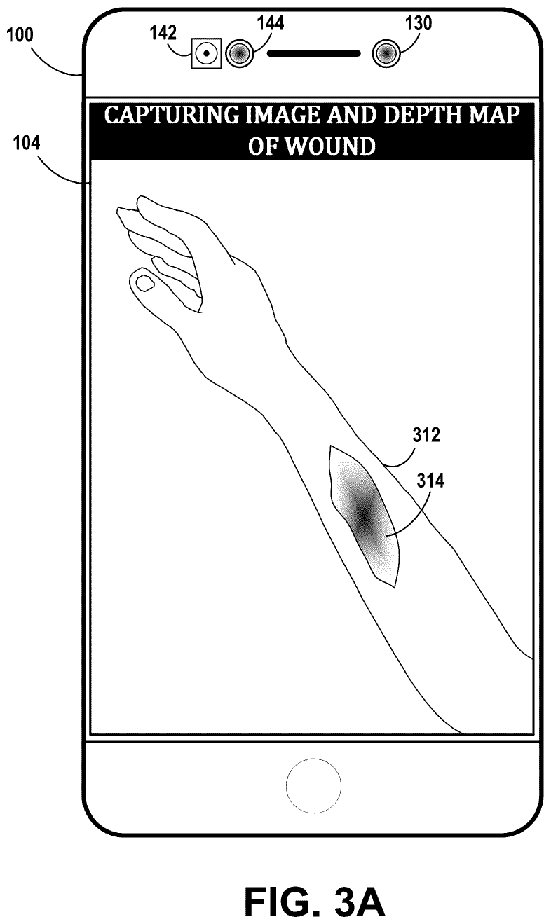

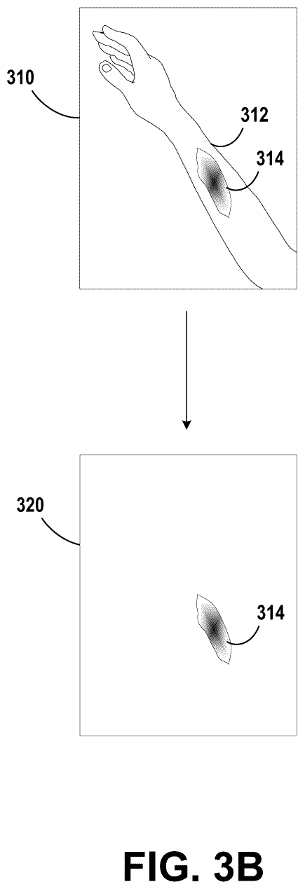

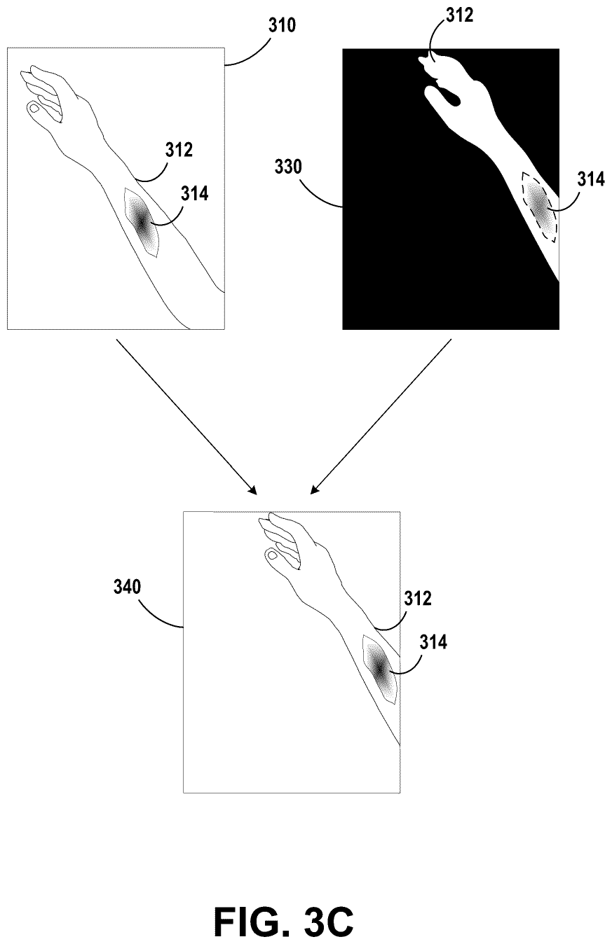

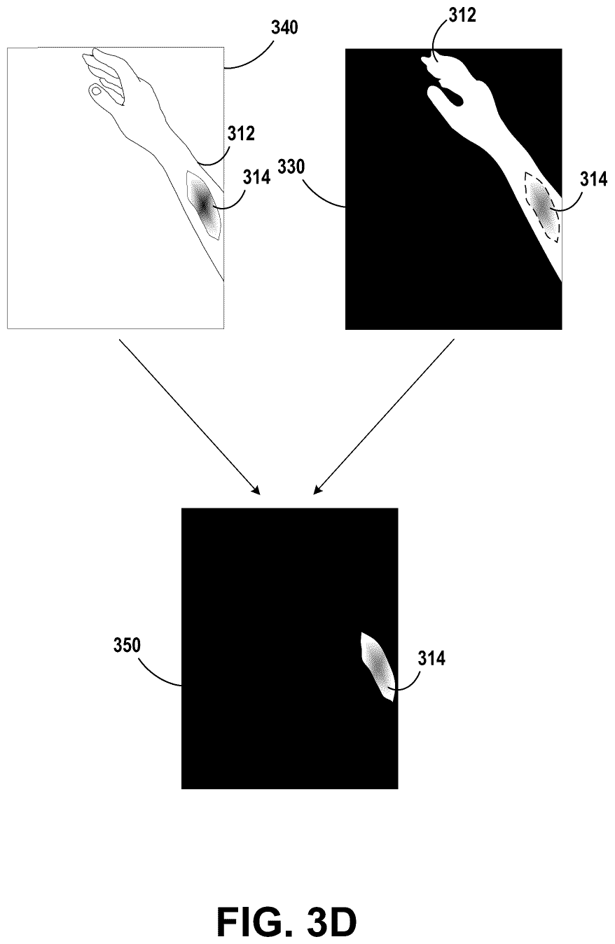

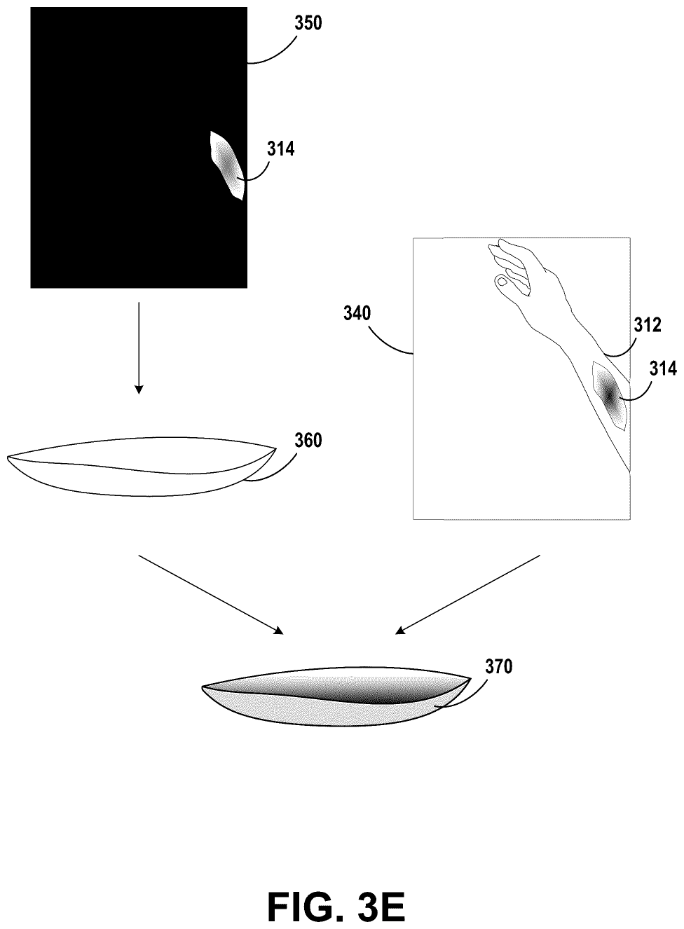

FIG. 3A is an illustration of a device (e.g., the device 100 shown and described with reference to FIG. 1) capturing an image (e.g., a red-green-blue (RGB) image or an image in some other color space) and a depth map of a wound 314 (e.g., a wound 314 disposed on a limb 312 of a patient), according to example embodiments. Although the wound 314 and the limb 312 depicted in the drawings herein may correspond to a laceration and an arm, respectively, it is understood that other types of wounds and/or other limbs (or even wounds not disposed on limbs, such as a laceration on the chest) are also contemplated herein.

As illustrated, the device 100 may be a mobile computing device (e.g., a smartphone). However, it is understand that the techniques described herein are not limited to a mobile computing device. The device 100 (e.g., a processor of the device) may be executing an application (e.g., mobile app) in order to perform one or more of the techniques described herein. The image of the wound 314 may be captured using a camera 130 of the device 100 and the depth map of the wound 314 may be captured using the depth sensor (e.g., the infrared emitter(s) 142 and the infrared-sensitive pixels 144) of the device 100. As illustrated, the camera 130, the infrared emitter(s) 142, and the infrared-sensitive pixels 144 may be positioned on the front face of the device 100 (i.e., the face of the device 100 on which a primary display is located). However, it is understood that, in other embodiments, the camera 130, the infrared emitter(s) 142, and/or the infrared-sensitive pixels 144 could be located on another face of the device 100 (e.g., a rear face of the device 100). As also illustrated, during image and depth map capture, a display (e.g., a display of the user interface 104) may serve as a viewfinder (e.g., may display an RGB image that is currently being captured by the camera 130). Further, in some embodiments, in order to execute a capture action of the image of the wound 314 and/or the depth map of the wound 314, a button (e.g., a shutter button at the bottom of the user interface 104 of the device 100) may be pressed (e.g., by a user).

Upon being captured, the image of the wound 314 and/or the depth map of the wound 314 may be stored within a memory (e.g., a memory of the device 100 and/or a remote memory, such as a cloud memory) for subsequent analysis. For example, the image of the wound 314 and/or the depth map of the wound 314 may be stored within a volatile memory (e.g., a random-access memory (RAM) of the device 100) and/or within a non-volatile memory (e.g., a hard drive of the device 100).

FIG. 3B is an illustration of an identification of a region of an image that corresponds to a wound, according to example embodiments. For example, an image 310 (e.g., an RGB image) of the wound 314 may have been captured using the device 100. Such an image 310 may have been stored (e.g., in a memory) and then retrieved for analysis (e.g., retrieved for the analysis described in FIG. 3B and the succeeding figures). Whereas the image 310 may include each object captured by the camera, the revised image 320 may only include a region of the image 310 that corresponds to the wound 314.

In some embodiments, identifying which portion of the image 310 includes the wound 314 may include analyzing the image 310 using a machine-learned model (e.g., one of the machine-learned models 230 shown and described with reference to FIGS. 2A and 2B). For example, a machine-learned model may have been trained (e.g., using labeled training data, such as an image repository that include previously captured images with labeled wound regions) for object detection/identification. Specifically, the machine-learned model may have been trained to identify wounds within images. In some embodiments, for instance, an object-detection model that was built in TENSORFLOW and converted to COREML (e.g., to enhance efficiency when used by a mobile computing device) may be used by the device 100 to determine which region(s) of the image 310 correspond to the wound 314. Further, in some embodiments, the machine-learned model may take only images for inputs that have specific aspect ratios and/or image resolutions. In such cases, the image 310 may be upsampled, upscaled, downsampled, downscaled, and/or cropped prior to feeding the image 310 to the machine-learned model. For example, the image 310 may be captured at a resolution of 4032×3024, but cropped to a square aspect ratio (e.g., 3024×3024) and then downscaled to a lower resolution (e.g., 512×512) before being fed into the machine-learned model.

Once the region containing the wound 314 has been identified (e.g., the revised image 320 has been determined), the bounds of the region of the image 310 may be output. For example, a rectangle may be determined that bounds the region of the wound 314. In such a case, the smallest x-coordinate, smallest y-coordinate, largest x-coordinate, and largest y-coordinate that define the four sides of the rectangle may be output. It is understood that bounding regions other than rectangles may also be used (e.g., circles, triangles, pentagons, hexagons, etc.). Additionally or alternatively, in some embodiments, the revised image 320 may only represent the bounded region of the image 310 corresponding to the wound 314 (i.e., the rest of the image may have been cropped out entirely rather than set to a default value or 0 value) and may also include metadata that indicates which portion of the image 310 the revised image 320 was taken from.

FIG. 3C is an illustration of an alignment of an image (e.g., the image 310 shown and described with reference to FIGS. 3A and 3B) and a depth map 330, according to example embodiments. The depth map 330 may have been captured by a depth sensor 140 (e.g., the depth sensor 140 shown and described with reference to FIGS. 1 and 3A). In some embodiments, the depth map 330 may have been captured substantially simultaneously with the image 310 (e.g., within 1 s of, within 100 ms of, within 10 ms of, within 1 ms of, within 100 μs of, within 10 μs of, or within 1 μs of the image 310 being captured). Throughout this disclosure, embodiments making use of a single image 310 of a wound 314 and a single depth map 330 of a wound 314 are shown and described. It is understood, however, that other embodiments are also possible and are contemplated herein. For example, instead of a single image 310 and a single depth map 330, multiple images 310 and depth maps 330 of the same wound 314/limb 312 could be captured and analyzed. The results of such analyses could be averaged or combined in another fashion in order to yield results (e.g., in order to produce a three-dimensional reconstruction). Even further, in some embodiments, rather than capturing discrete images 310/depth maps 330, a video stream (e.g., a series of consecutive images) and a depth stream (e.g., a series of consecutive depth maps) could be captured (e.g., the by the camera 130 and the depth sensor 140, respectively). Such video streams and depth streams may include images and depth maps captured from different perspectives (e.g., if the device 100 is translated and/or rotated relative to the wound during video stream/depth stream capture). In some embodiments, multiple perspectives may enhance results (e.g., the resulting generated three-dimensional models).

As shown in FIG. 3C, a realigned image 340 may be generated based on the input image 310 and the input depth map 330. Such a realigned image 340 may be produced using transformations determined based on predetermined extrinsics of the camera 130 used to capture the image 310 and/or predetermined extrinsics of the depth sensor 140 used to capture the depth map 330. For example, if the camera 130 and/or depth sensor 140 of a mobile computing device (e.g., produced by a manufacture such as APPLE) is used to capture the image 310 and the depth map 330, an extrinsic matrix for the camera 130 (e.g., based on optical characteristics of the image sensor and/or one or more lenses of the camera 130) may be determined and stored within data 112 (e.g., application data 114) of the data storage 108 of the device 100. Likewise, an extrinsic matrix for the depth sensor 140 (e.g., based on optical characteristics of the image sensor and/or one or more lenses of the depth sensor 140) may be determined and stored within data 112 (e.g., application data 114) of the data storage 108 of the device 100. Such extrinsic matrices may be usable to perform transformations that negate optical aberrations resulting from one or more imaging optics of the camera 130 used to capture the image 310 and/or one or more imaging optics the depth sensor 140 used to capture the depth map 330. In some embodiments, the extrinsics of the camera 130 and/or the extrinsics of the depth sensor 140 may be accessible to an application (e.g., a mobile app executing the image processing techniques described herein) via a manufacturer's API, which may provide information about the components of the device 100 as measured by the manufacturer of the device 100. Additionally or alternatively, extrinsics of the camera 130 and/or the depth sensor 140 may have been previously measured using one or more calibration measurements (e.g., using one or more calibration targets). The results of such calibration measurement(s) may be stored within data 112 (e.g., as extrinsic matrices).

In addition to or instead of one or more of the extrinsic matrices corresponding to the camera 130 and/or the depth sensor 140, aligning the image 310 and the depth map 330 may make use of one or more disparity matrices. For example, based on the separation between the depth sensor 140 and the camera 130 on the front face of the device (e.g., as measured by and/or designed by the manufacturer), a disparity matrix may be generated (e.g., and stored within the data storage 108 and accessible using an API). The disparity matrix may indicate the distance (e.g., in units of length, such as meters, and/or in units of pixels) that each pixel within the depth map 330 is offset (e.g., in the x-direction and in the y-direction) from a corresponding pixel within the image 310. Alternatively, the disparity matrix may represent the converse (i.e., the amount that each pixel within the image 310 is offset from a corresponding pixel within the depth map 330).

Aligning the image 310 to the depth map 330 to generate the realigned image 340 may involve applying an image transformation to the image 310 (e.g., to account for the x-y separation between the camera 130 and the depth sensor 140 and/or to compensate for optical aberrations/distortions present within imaging optics, such as lenses, of the camera 130 and/or the depth sensor 140). Such an image transformation may be determined based on a disparity matrix, an extrinsic matrix corresponding to the camera 130 used to capture the image 310, and/or an extrinsic matrix corresponding to the depth sensor 140 used to capture the depth map 330. While example embodiments described herein involve aligning the image 310 to the depth map 330 and then making use of the identified wound within the image 310 to make determinations about wound 314 location within the depth map 330, it is understood that the other embodiments are also possible. For example, the depth map 330 could instead be aligned to the image 310. In such embodiments, a machine-learned model (e.g., trained using depth maps with labeled wounds as training data) may instead determine the region of the depth map 330 that includes the wound 314 and then determine the corresponding region of image 310 that includes the wound 314.

In addition to performing an image transformation (e.g., based on a disparity matrix or one or more extrinsic matrices), aligning the image 310 to the depth map 330 may include accommodating inherent differences in the imaging modalities (e.g., that arise as a result of differences between the camera 130 and the depth sensor 140). For example, in some embodiments, the dimensions and/or resolution of the image 310 may be different from the dimensions and/or resolution of the depth map 330. In such embodiments, one or both of the image 310 and/or the depth map 330 may be cropped in order to have the same dimensions and/or downscaled in order to have the same resolution. This may allow the image 310 and the depth map 330 to be more meaningfully compared to one another (e.g., may make the region of the image 310 that includes the wound 314 more directly correspond to the region of the depth map 330 that includes the wound 314).

The output from FIG. 3B (e.g., the coordinates of the image 310 that represent the region of the image 310 that corresponds to the wound 314) and the output from FIG. 3C (e.g., the realigned image of the wound 314) may be used in combination to determine the region of the depth map 330 that corresponds to the wound 314, as shown and described with reference to FIG. 3D.

FIG. 3D is an illustration of a determination of a region of a depth map that corresponds to a wound, according to example embodiments. As described with reference to FIG. 3B, techniques described herein may include determining a region of the image 310 that includes the wound 314. Thereafter, as described with reference to FIG. 3C, the image 310 can be aligned with the depth map 330. This may provide a one-to-one correlation between pixels in the realigned image 340 and pixels in the depth map 330. As a result, the portion of the realigned image 340 that includes the wound 314 may directly correspond to the portion of the depth map 330 that includes the wound 314. Once the portion of the depth map 330 that corresponds to the wound 314 has been determined, a revised depth map 350 may be generated. The revised depth map 350 may have the non-wound regions of the depth map 330 removed. For example, in some embodiments, all of the depth values in the non-wound regions of the depth map 330 may be converted to a default value in the revised depth map 350. Alternatively, all of the non-wound regions of the depth map 330 may be entirely removed from the revised depth map 350 by cropping the revised depth map 350 such that only portions of that correspond to the wound 314 region remain. If such a cropping is performed, metadata may be retained that indicates which pixel positions (e.g., x-locations and y-locations) of the depth map 330 the revised depth map 350 was extracted from.

The output from FIG. 3C (e.g., the realigned image 340 of the wound 314) and the output from FIG. 3D (e.g., the revised depth map 350) may be used in combination to generate a colorized, three-dimensional reconstruction of the wound 314, as shown and described with reference to FIG. 3E.

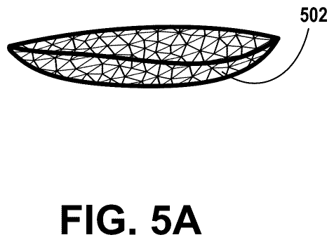

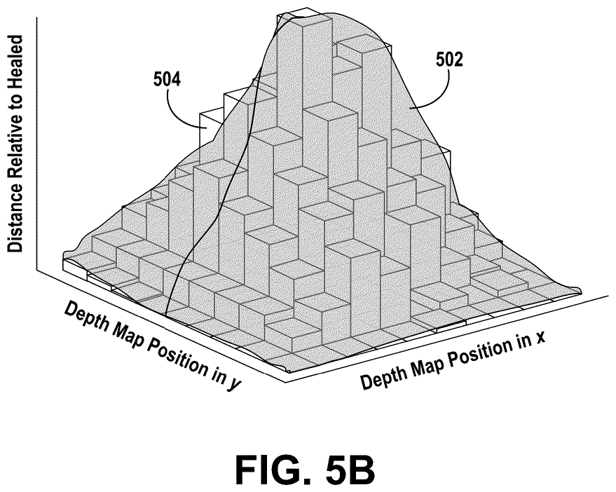

FIG. 3E is an illustration of a generation of a three-dimensional reconstruction 360 of a wound and an application of one or more colorations to the three-dimensional reconstruction to produce a colorized reconstruction 370, according to example embodiments. Upon identifying the portions of the depth map 330 that correspond to the wound 314 (e.g., upon generating the revised depth map 350), a three-dimensional reconstruction 360 (i.e., three-dimensional representation) of the wound 314 can be generated. This may be done using the depth values at each pixel within the depth map 330/revised depth map 350 that are within the region corresponding to the wound 314 along with the x-location and y-location of those pixels to form a series of [x, y, z] positions. By plotting each of the [x, y, z] positions together, the three-dimensional reconstruction 360 may be produced. In some embodiments, a meshing algorithm may form a continuous surface profile representing the wound 314 based on the [x, y, z] positions (e.g., by interpolating the three-dimensional location of points located between the identified [x, y, z] positions). An example mesh is shown and described below with reference to FIG. 5A. In some embodiments, the generation of the three-dimensional reconstruction 360 and/or the production of the colorized reconstruction 370 may be performed using one or more libraries. For example, one or more programming libraries (e.g., Point Cloud Library, Open3D, or OpenCV) may be used in the generation of the three-dimensional reconstruction 360 and/or the production of the colorized reconstruction 370.

Further, because the image 310 and the depth map 330 may have already been aligned to one another (e.g., by generating the realigned image 310), each of the pixels (e.g., at a given [x, y] position) of the wound 314 from the depth map 330/revised depth map 350 directly corresponds to a pixel (e.g., at a given [x, y] position) from the image 310/realigned image 340. Given this, each of the [x, y, z] positions corresponding to the wound 314 in the three-dimensional reconstruction 360 can be colorized using color values (e.g., RGB values, CMYK values, YCbCr values, etc.) from the corresponding pixel (e.g., at a given [x, y] position) on the image 310/realigned image 340. Upon applying the corresponding coloration to each of the points in the three-dimensional reconstruction 360, a colorized reconstruction 370 may be produced.

In various embodiments, the colorized reconstruction 370 may be stored (e.g., within a memory for later analysis) and/or used for diagnostics. For example, the colorized reconstruction 370, data determined based on the colorized reconstruction 370 (e.g., wound coloration, wound depth, wound surface area, wound volume etc.), and/or data determined over time based on one or more colorized reconstructions determined at different healing stages (e.g., change in wound coloration over time, change in wound depth over time, change in wound surface area over time, change in wound volume over time, etc.) may be provided to a patient, provided to a medical professional (e.g., a physician, a clinician, a nurse, etc.) for diagnosis or treatment of the wound 314, and/or stored within a memory (e.g., a non-volatile storage, such as cloud storage). In various embodiments, such information may be distributed in various ways. For example, a patient and/or a medical professional (e.g., the patient's primary care physician) may receive the information via an electronic health record upload, a text message, one or more notifications on an app (e.g., the app performing the image and depth map capture/analysis described herein), an email, a browser-based web interface, etc.

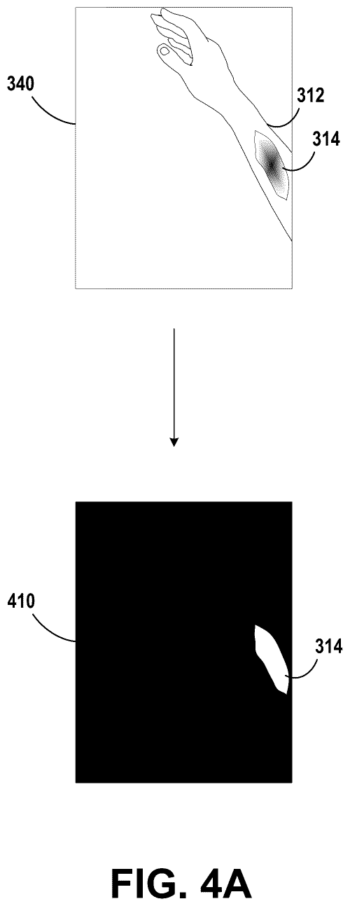

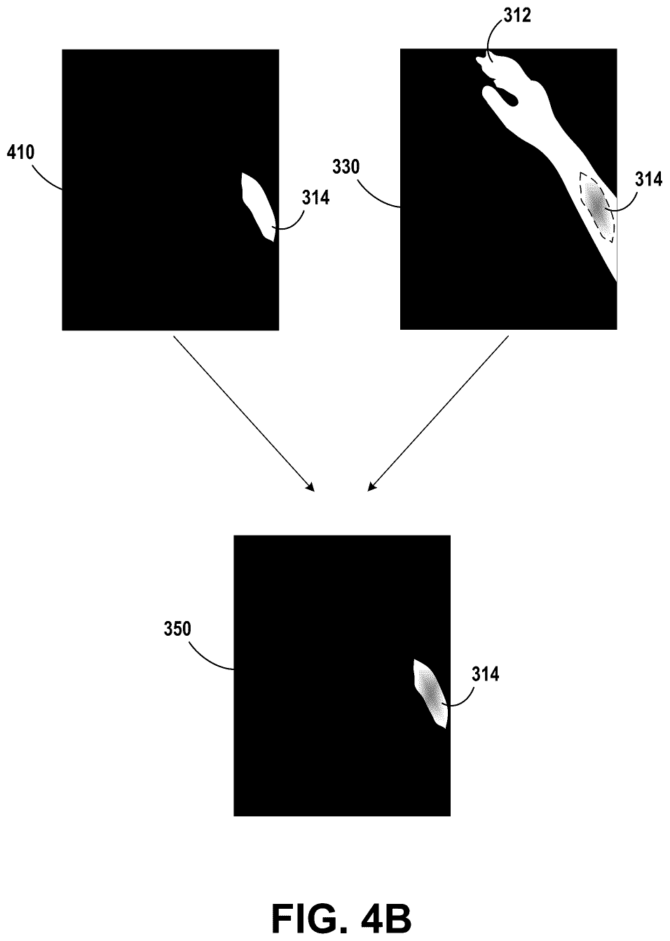

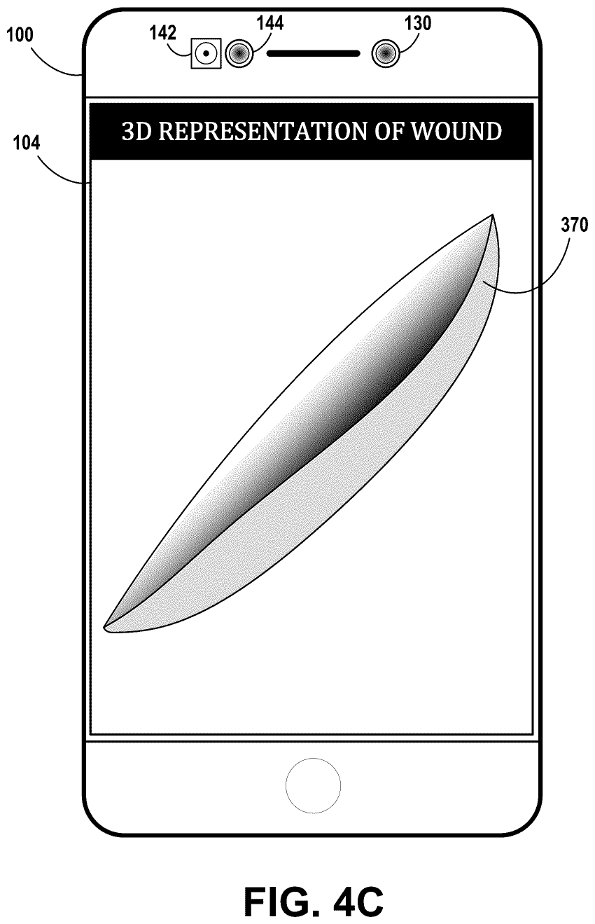

FIG. 4A is an illustration of a generation of a wound mask 410, according to example embodiments. In some embodiments, in order to assist in determining which region of the depth map 330 corresponds to the wound 314 (e.g., in order to assist with the technique shown and described above with reference to FIG. 3D), the wound mask 410 may be generated based on the realigned image 340 (as illustrated in FIG. 3D) and/or the original image 310. Generating the wound mask 410 may include applying a machine-learned model (e.g., a machine-learned model for segmentation) to the realigned image 340 and/or the original image 310 based on the region of the image that corresponds to the wound (e.g., as identified using a machine-learned model for object detection, as shown and described above with reference to FIG. 3B). The wound mask 410 may be an array that has all entries corresponding to non-wound pixels set to one value (e.g., 0) and all entries corresponding to wound pixels set to another value (e.g., 255).

In some embodiments, the wound mask 410 may be denoised (e.g., to remove artifacts generated as a result of image rescaling or resizing or as a result of applying the machine-learned model for segmentation) prior to using the wound mask 410 for further steps (e.g., prior to the technique described below with respect to FIG. 4B). Denoising the wound mask 410 may include applying one or more image processing techniques (e.g., morphological transformations) from one or more image processing libraries (e.g., OpenCV). For example, the floodfill( ) function from the OpenCV library may be used. Additionally or alternatively, the wound mask 410 may be upscaled, downscaled, cropped, and/or padded prior to using the wound mask 410 for further steps (e.g., prior to the technique described below with respect to FIG. 4B). For example, if the depth map 330 has a different resolution and/or aspect ratio than the realigned image 340/image 310 according to which the wound mask 410 was generated, the wound mask 410 may also then have a different resolution and/or aspect ratio than the depth map 330. Hence, in order to be readily applied to the depth map 330, the dimensions and/or resolution of the wound mask 410 may be modified to match the dimension and/or resolution of the depth map 330.

FIG. 4B is an illustration of an application of a wound mask 410 to a depth map 330, according to example embodiments. The wound mask 410 may correspond to the wound mask 410 generated using the technique shown and described above with reference to FIG. 4A. The depth map 330 may correspond to the depth map 330 shown and described above with reference to FIG. 3C. The wound mask 410 may be applied to the depth map 330 to identify which portions of the depth map 330 correspond to the wound (e.g., as part of the determination shown and described above with reference to FIG. 3D), resulting in the revised depth map 350. As illustrated in FIG. 4B, the revised depth map 350 may include the depth values in a region that corresponds to the wound 314, but include default values (e.g., values of 0) in regions outside of the region that corresponds to the wound 314.

In some embodiments, upon applying the wound mask 410 to the depth map 330, the region that corresponds to the wound 314 (e.g., the region of the revised depth map 350 that corresponds to the wound 314) may be denoised (e.g., to remove artifacts and/or address data capture errors). Denoising the portions of the depth map related to the wound may include eliminating or adjusting depth values that are outside of a range of depths from a lower threshold depth to an upper threshold depth. For example, an average depth value of the portions corresponding to the wound 314 may be calculated and, based on this average, a lower threshold depth and an upper threshold depth may be determined. For instance, a lower threshold may be set some amount below the average depth value (e.g., 1 cm, 2 cm, 3 cm, 4 cm, 5 cm, etc.) below the average depth value and an upper threshold may be set some amount above the average depth value (e.g., 1 cm, 2 cm, 3 cm, 4 cm, 5 cm, etc.) above the average depth value. More sophisticated thresholding techniques are also possible and are contemplated herein. Once the thresholds are set, any depth values within the wound 314 region of the depth map 330 that are not between the thresholds may be adjusted (e.g., may be replaced by depth values determined using nearest-neighbor interpolation for pixels near the periphery of the wound 314 and/or inpainting for pixels near the center of wound 314). Likewise, some pixels within the wound 314 region of the depth map 330 may have no depth value provided (e.g., as a result of one or more detection errors of the depth sensor 140 used to initially detect the depth map 330, which may be caused by poor lighting, movement of the depth sensor 140 or the subject during data capture, or one or more occlusions). Any pixels within the wound 314 region of the depth map 330 for which no depth value was provided (e.g., indicated by a “nil” or “NaN” indicator) may be adjusted (e.g., may be replaced by depth values determined using nearest-neighbor interpolation for pixels near the periphery of the wound 314 and/or inpainting for pixels near the center of wound 314).

In some embodiments, in addition to or instead of identifying one or more thresholds, denoising the portions of the depth map related to the wound may include eliminating or adjusting depth values using alternative techniques. For example, a lower quartile and an upper quartile may be computed for the depth values within the wound region and then any depth values which are outside of the interquartile range between the lower quartile and upper quartile may be adjusted. Additionally or alternatively, one or more clustering techniques may be used to identify one or more depth values for adjustment/elimination. Still further, alternative techniques for denoising within the OpenCV library may be used.

FIG. 4C is an illustration of a displaying of a colorized three-dimensional reconstruction of a wound, according to example embodiments. For example, as illustrated in FIG. 4C, in some embodiments, the colorized reconstruction 370 (e.g., as shown and described with reference to FIG. 3E) may be displayed on a display (e.g., a touchscreen) of the user interface 104. As the colorized reconstruction 370 is a complete three-dimensional representation, the colorized reconstruction 370 may be rotated and/or zoomed into or out from (e.g., by a user interacting with the touchscreen using one or more rotation or zoom commands). While the colorized reconstruction 370 is illustrated in FIG. 4C, it is understood that, in some embodiments, the three-dimensional reconstruction 360 could additionally or alternatively be displayed on a display. Further, in some embodiments, the colorized reconstruction and/or the three-dimensional reconstruction 360 may be displayed relative to (e.g., positioned within or upon) a three-dimensional reconstruction of a limb (e.g., similar to the wound 314 within the limb 312 contained within the image 310 as shown and described with reference to FIG. 3B). In some embodiments, one or more programming libraries for app development (e.g., SCENEKIT for APPLE IOS) may be used to display the three-dimensional reconstruction 360, the colorized reconstruction 370, a three-dimensional reconstruction of a limb, etc.

FIG. 5A is an illustration of a generated mesh 502, according to example embodiments. The mesh 502 may represent the surface profile of a wound 314 (e.g., may correspond to the three-dimensional reconstruction 360 of the wound 314). The mesh 502 may be generated using one or more programming libraries (e.g., Point Cloud Library, Open3D, or OpenCV), in some embodiments. Additionally, the mesh 502 may be generated by setting each of the points within the region of the depth map 330 corresponding to the wound 314 as a node. Each of the nodes may then be connected in such a way to form polygonal (e.g., triangular) faces that show the surface profile of the wound 314. These polygonal faces may also be used to determine the surface area of the mesh 502 (and, thereby, the surface area of the wound 314). For example, a cross product may be determined by each of the component vectors for each face of the mesh 502. Then, the magnitudes of each of the computed cross products may be summed to determine the surface area of the entire mesh 502 (e.g., in the case of triangular faces, each of the magnitudes may be divided by two prior to summing the cross products).

Additionally or alternatively, in some embodiments, the mesh 502 may be colorized (e.g., as described above with reference to the colorized reconstruction 370). Colorization may include applying the corresponding colors from the image 310 or the realigned image 340 to the nodes and/or faces of the mesh 502. Further, colorization may also make use of one or more programming libraries, in some embodiments.

In addition to the surface area of the wound 314, the mesh 502 may also be used to calculate a depth of the wound 314 and/or a volume of the wound 314. For example, FIG. 5B is an illustration of a calculation of a wound volume, according to example embodiments. In order to determine a wound volume and/or a wound depth, a representation of a healed wound may first be determined.

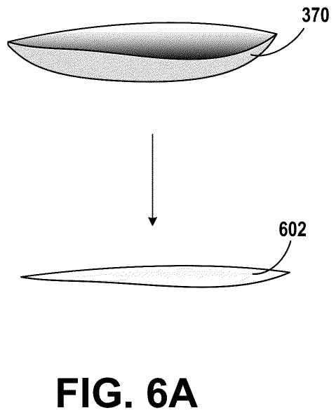

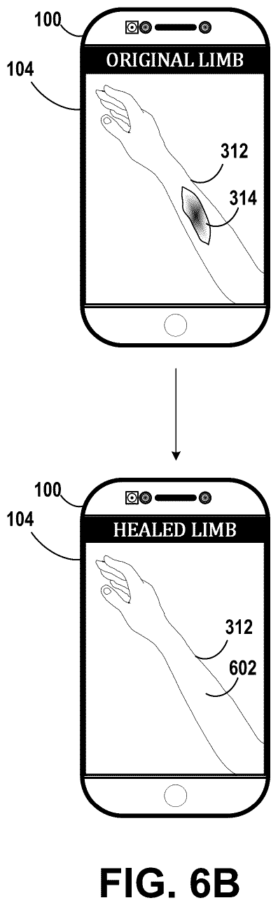

FIG. 6A is an illustration of a generation of a three-dimensional reconstruction of a healed wound 602, according to example embodiments. The three-dimensional reconstruction of the healed wound 602 may be generated (and displayed, as described below with reference to FIG. 6B) relative to the colorized reconstruction 370, for example. In order to generate the three-dimensional reconstruction of the healed wound 602, a region of the image 310 (e.g., the image 310 captured of the wound 314) that corresponds to the limb 312 may be identified. Identifying the region of the image 310 that corresponds to the limb 312 may include applying a machine-learned model for limb identification (e.g., a machine-learned model that was trained using training data that included images in which regions corresponding to limbs were labeled). Upon identifying the portion of the image 310 that corresponds to the limb 312, a combined mask may be generated based on the identified portion. The combined mask may correspond to regions of the image 310 (and/or the realigned image 340) and regions of the depth map 330 that include the wound 314 or the limb 312 associated with the wound 314. The combined mask is “combined” in the sense that it include both the wound 314 and the limb 312.

Upon determining the combined mask, the combined mask may be applied to the depth map 330 to remove portions of the depth map 330 other than the wound 314 and the limb 312. Thereafter, a first series of depth values associated with the portions of the depth map 330 corresponding to the wound and a second series of depth values associated with portions of the depth map 330 corresponding to the limb 312 may be determined. Then, using the portion of the depth map 330 that corresponds to the limb 312 (but that does not correspond to the wound 314), revised depth values corresponding to a healed wound may be determined. Revised depth values corresponding to a healed wound may be determined by inpainting the portion of the depth map 330 that correspond to the wound 314 based on portions of the depth map 330 that correspond to the limb 312. In other words, an estimation may be made of what the surface profile of the limb 312 would be in the region of the depth map 330 corresponding to the wound 314 if the wound 314 were not present but instead that region of the depth map 330 simply followed the expected natural contour of the rest of the limb 312. This inpainting step may make use of both the combined mask and a wound mask (e.g., the wound mask 410 shown and described above with reference to FIGS. 4A and 4B). Further, this inpainting step may include applying a machine-learned model for inpainting. The machine-learned model may be trained on a series of depth maps corresponding to uninjured (e.g., healed) limbs. Such depth maps used for training data may include synthetic depth maps (e.g., including altered depth maps of injured limbs to reflect the appearance of a healed limb and/or altered depth maps that represent various perspectives of the same healed limb from which only one depth map was actually captured). In some embodiments, the machine-learned model used for this depth inpainting step may be a GAN.

It is understood that, in other embodiments, other representations of wound healing are also possible. For example, one or more depth inpainting machine-learned models could be trained on intermediate healing states (e.g., partially healed wounds) rather than fully healed wounds. In such embodiments, different machine-learned models could be applied to determine depth values corresponding to different healing states (e.g., different time periods since injury; different patient healing characteristics, such as different ages; different treatment regimens; etc.). Additionally or alternatively, machine-learned models used to colorize different healing states may also be trained. For example, one or more machine-learned models may be trained on RGB images of uninjured (e.g., healed) limbs in various states of healing (e.g., fully healed or partially healed). Coloration characteristics defined for various healing states or complication states (e.g., tissues experiencing infection, hypergranulation, necrosis, etc.) based on these machine-learned models could also be applied to depth values generated for a healed wound (e.g., to represent different colorations in different stages of healing, including fully healed). Each of these possibilities is contemplated herein.

Upon determining three-dimensional reconstruction of the healed wound 602, the three-dimensional reconstruction of the healed wound 602 may be colorized and/or displayed.

For example, one or more colorations may be applied to the three-dimensional reconstruction of the healed wound 602 based on one or more colorations in the region of the image 310 that correspond to the limb 312 associated with the original wound 314. In other words the otherwise uninjured regions of the limb 312 in the initial image 310 may be used to approximate the coloration of the three-dimensional reconstruction of the healed wound 602. Additionally or alternatively, the three-dimensional reconstruction of the healed wound 602 may be displayed (e.g., on a display of a user interface 104 of the device 100). FIG. 6B, for example, is an illustration of a displaying of a wound healing, according to example embodiments. In some embodiments, the three-dimensional reconstruction of the healed wound 602 may be overlaid on the limb 312, as illustrated. Additionally or alternatively, in some embodiments, a limb with the three-dimensional reconstruction of the healed wound 602 may be displayed adjacent to (e.g., within the same user interface) or subsequent to (e.g., within consecutive user interfaces, as illustrated in FIG. 6B) the original image 310 (e.g., displaying the currently captured state of the wound 314).

Returning to FIG. 5B, the depth values of the three-dimensional reconstruction of a healed wound 602 (e.g., as determined using the techniques described above with reference to FIG. 6A) may be used to determine the volume of the wound 314. For example, the inpainted depth values of the three-dimensional reconstruction of a healed wound 602 may be compared (on a pixel-by-pixel basis) to the depth values of the mesh 502 (e.g., the mesh 502 shown and described with reference to FIG. 5A) of the wound 314. The differences in depth value for each pixel may then be multiplied by an effective surface area (e.g., a surface area of an infrared-sensitive pixel within the depth sensor which was used to capture the depth map 330) to determine the volume of an associated voxel 504 and the volume of each of the voxels may then be summed to determine an effective volume of the wound 314. In addition to or instead of determining wound 314 volume, wound depth may also be determined. For example, the greatest difference among all pixel-by-pixel depth comparisons may be identified as the effective depth of the wound 314. While example embodiments shown and described with reference to FIG. 5B disclose making depth and volume calculations using the generated mesh 502, it is understood that, in some embodiments, the use of the mesh 502 is not necessary. For example, the inpainted depth values of the healed wound could instead be directly compared to corresponding regions of the depth map 330 without first generating a mesh 502.

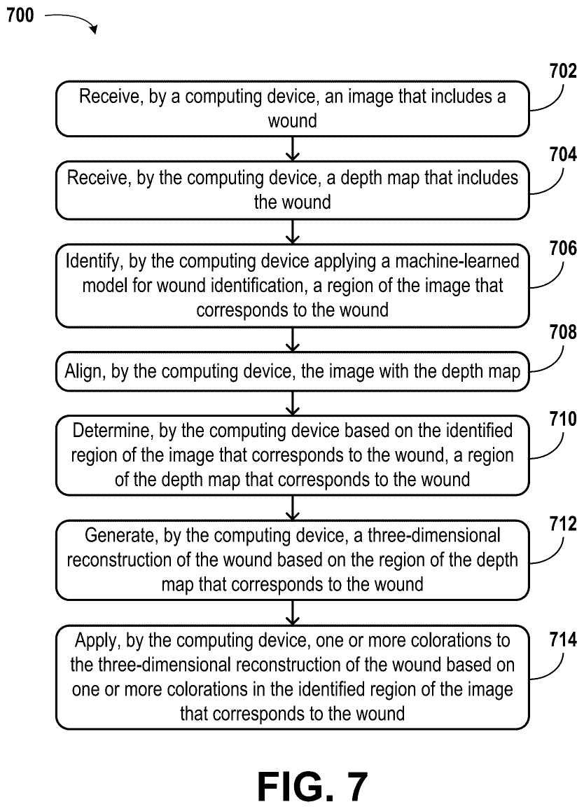

FIG. 7 is a flowchart diagram of a method 700, according to example embodiments. In some embodiments, the method 700 may be performed by a device (e.g., the device 100 shown and described with reference to FIG. 1). The method 700 may be performed to generate a three-dimensional reconstruction of a wound, for example.

At block 702, the method 700 may include receiving, by a computing device, an image that includes a wound.

At block 704, the method 700 may include receiving, by the computing device, a depth map that includes the wound.

At block 706, the method 700 may include identifying, by the computing device applying a machine-learned model for wound identification, a region of the image that corresponds to the wound.

At block 708, the method 700 may include aligning, by the computing device, the image with the depth map.

At block 710, the method 700 may include determining, by the computing device based on the identified region of the image that corresponds to the wound, a region of the depth map that corresponds to the wound.

At block 712, the method 700 may include generating, by the computing device, a three-dimensional reconstruction of the wound based on the region of the depth map that corresponds to the wound.

At block 714, the method 700 may include applying, by the computing device, one or more colorations to the three-dimensional reconstruction of the wound based on one or more colorations in the identified region of the image that corresponds to the wound.

In some embodiments, the method 700 may also include displaying, by the computing device on a display, the colorized three-dimensional reconstruction of the wound.

In some embodiments of the method 700, the image may have been captured by a camera of a mobile computing device. Further, the depth map may have been captured by a depth sensor of a mobile computing device. In some embodiments of the method 700, the camera of the mobile computing device may include a front-facing camera of the mobile computing device. Additionally, the depth sensor of the mobile computing device may include one or more infrared emitters configured to project an array of infrared signals into a surrounding environment, an array of infrared-sensitive pixels configured to detect reflections of the array of infrared signals from objects in the surrounding environment, and a controller configured to determine depth based on the infrared signals detected by the array of infrared-sensitive pixels.

In some embodiments of the method 700, the image may be captured in red-green-blue (RGB) color space. Further, the one or more colorations may be applied using RGB values.

In some embodiments, the method 700 may also include cropping, by the computing device, the image or the depth map such that the image and the depth map have the same dimensions. Further, the method 700 may include downscaling, by the computing device, the image or the depth map such that the image and the depth map have the same resolution.

In some embodiments, the method 700 may include modifying, by the computing device, a resolution of the image so the resolution matches an input resolution of the machine-learned model for wound identification. Further, the method 700 may include modifying, by the computing device, an aspect ratio of the image so the aspect ratio matches an input aspect ratio of the machine-learned model for wound identification.

In some embodiments, the method 700 may include transforming, by the computing device, the image to negate optical aberrations resulting from one or more imaging optics of a camera used to capture the image.

In some embodiments, the method 700 may include generating, by the computing device using a machine-learned model for segmentation, a wound mask for the image based on the identified region of the image that corresponds to the wound. Further, the method 700 may include denoising, by the computing device, the wound mask. Additionally, in some embodiments, the method 700 may include applying, by the computing device, the wound mask to the depth map in order to isolate portions of the depth map related to the wound. Even further, in some embodiments, the method 700 may include denoising, by the computing device, the portions of the depth map related to the wound. Denoising the portions of the depth map related to the wound may include eliminating or adjusting depth values that are outside of a range of depths from a lower threshold depth to an upper threshold depth. Additionally or alternatively, in some embodiments, the method 700 may include identifying, by the computing device, one or more missing depth values within the portions of the depth map related to the wound. Still yet further, the method 700 may include replacing, by the computing device, the missing depth values using nearest-neighbor interpolation or inpainting.

In some embodiments, the method 700 may include generating, by the computing device, a mesh based on the three-dimensional reconstruction. The mesh may represent a surface profile of the wound. Additionally, the method 700 may include determining, by the computing device, a surface area of the wound. Determining the surface area of the wound may include computing, by the computing device for each face of the mesh, a cross-product of two component vectors of the face. Determining the surface area of the wound may also include summing, by the computing device, magnitudes of the computed cross-products. In addition, the method 700 may include determining, by the computing device, a volume of the wound. Determining the volume of the wound may include identifying, by the computing device applying a machine-learned model for limb identification, a region of the image that corresponds to a limb associated with the wound. Determining the volume of the wound may also include generating, by the computing device, a combined mask. The combined mask may represent regions of the image and the depth map that correspond to either the wound or the limb associated with the wound. The combined mask may be generated based on the identified region of the image that corresponds to the wound and the identified region of the image that corresponds to the limb associated with the wound. Additionally, determining the volume of the wound may include determining, by the computing device by applying the combined mask to the depth map, a first series of depth values and a second series of depth values. The first series of depth values may be associated with portions of the depth map corresponding to the wound. The second series of depth values may be associated with portions of the depth map corresponding to the limb associated with the wound. Further, determining the volume of the wound may include determining, by the computing device by applying a machine-learned model for inpainting, a revised first series of depth values. The revised first series of depth values may correspond to an inpainting of a portion of the depth map corresponding to the wound using the second series of depth values as a basis. The revised first series of depth values may represent depth values that would result from the wound healing. In addition, determining the volume of the wound may include calculating, by the computing device for each point within the portion of the depth map corresponding to the wound, a volume of a voxel associated with the point. Calculating the volume of the voxel may include calculating, by the computing device, a difference between a respective depth value of the first series of depth values associated with that point and a respective depth value of the revised first series of depth values associated with that point. Calculating the volume of the voxel may also include multiplying, by the computing device, the difference by a pixel area . The pixel area may correspond to an area of an infrared-sensitive pixel within a depth sensor used to capture the depth map. Even further, determining the volume of the wound may include calculating, by the computing device, wound volume by summing together each of the voxel volumes. Even still yet further, in some embodiments, the method 700 may include generating, by the computing device, a three-dimensional reconstruction of the wound healing based on the revised first series of depth values. Still even yet further, the method 700 may include applying, by the computing device, one or more colorations to the three-dimensional reconstruction of the wound healing based on one or more colorations in the identified region of the image that corresponds to the limb associated with the wound. Yet still even further, the method 700 may include displaying, by the computing device on a display, the colorized three-dimensional reconstruction of the wound healing. Yet even still further, in some embodiments, the method 700 may include determining, by the computing device, a wound depth. Determining the wound depth may include identifying, by the computing device, a greatest difference from among the differences calculated for each of the points within the portion of the depth map corresponding to the wound.

In some embodiments, the method 700 may include providing, by the computing device, the three-dimensional reconstruction of the wound to a user. The method 700 may also include storing, by the computing device, the three-dimensional reconstruction of the wound within a memory such that the three-dimensional reconstruction of the wound is later accessible for analysis.

### IV. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, operation, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step, block, or operation that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer-readable medium such as a storage device including RAM, a disk drive, a solid state drive, or another storage medium.

The computer-readable medium can also include non-transitory computer-readable media such as computer-readable media that store data for short periods of time like register memory and processor cache. The computer-readable media can further include non-transitory computer-readable media that store program code and/or data for longer periods of time. Thus, the computer-readable media may include secondary or persistent long term storage, like read-only memory (ROM), optical or magnetic disks, solid state drives, compact-disc read-only memory (CD-ROM), for example. The computer-readable media can also be any other volatile or non-volatile storage systems. A computer-readable medium can be considered a computer-readable storage medium, for example, or a tangible storage device.

Moreover, a step, block, or operation that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed:

1. A method comprising:
receiving, by a computing device, an image that includes a wound;
receiving, by the computing device, a depth map that includes the wound;
identifying, by the computing device applying a machine-learned model for wound identification, a region of the image that corresponds to the wound;
aligning, by the computing device, the image with the depth map;
determining, by the computing device based on the identified region of the image that corresponds to the wound, a region of the depth map that corresponds to the wound;
generating, by the computing device, a three-dimensional reconstruction of the wound based on the region of the depth map that corresponds to the wound; and
applying, by the computing device, one or more colorations to the three-dimensional reconstruction of the wound based on one or more colorations in the identified region of the image that corresponds to the wound.

2. The method of claim 1, further comprising displaying, by the computing device on a display, the colorized three-dimensional reconstruction of the wound.

3. The method of claim 1,
wherein the image was captured by a camera of a mobile computing device, and
wherein the depth map was captured by a depth sensor of a mobile computing device.

4. The method of claim 3,
wherein the camera of the mobile computing device comprises a front-facing camera of the mobile computing device, and
wherein the depth sensor of the mobile computing device comprises:
one or more infrared emitters configured to project an array of infrared signals into a surrounding environment;
an array of infrared-sensitive pixels configured to detect reflections of the array of infrared signals from objects in the surrounding environment; and
a controller configured to determine depth based on the infrared signals detected by the array of infrared-sensitive pixels.

5. The method of claim 1, wherein the image is captured in red-green-blue (RGB) color space, and wherein the one or more colorations are applied using RGB values.

6. The method of claim 1, further comprising:
cropping, by the computing device, the image or the depth map such that the image and the depth map have the same dimensions; or
downscaling, by the computing device, the image or the depth map such that the image and the depth map have the same resolution.

7. The method of claim 1, further comprising:
modifying, by the computing device, a resolution of the image so the resolution matches an input resolution of the machine-learned model for wound identification; or
modifying, by the computing device, an aspect ratio of the image so the aspect ratio matches an input aspect ratio of the machine-learned model for wound identification.

8. The method of claim 1, further comprising transforming, by the computing device, the image to negate optical aberrations resulting from one or more imaging optics of a camera used to capture the image.

9. The method of claim 1, further comprising:
generating, by the computing device using a machine-learned model for segmentation, a wound mask for the image based on the identified region of the image that corresponds to the wound; and
denoising, by the computing device, the wound mask.

10. The method of claim 9, further comprising applying, by the computing device, the wound mask to the depth map in order to isolate portions of the depth map related to the wound.

11. The method of claim 10, further comprising denoising, by the computing device, the portions of the depth map related to the wound, wherein denoising the portions of the depth map related to the wound comprises eliminating or adjusting depth values that are outside of a range of depths from a lower threshold depth to an upper threshold depth.

12. The method of claim 10, further comprising:
identifying, by the computing device, one or more missing depth values within the portions of the depth map related to the wound; and
replacing, by the computing device, the missing depth values using nearest-neighbor interpolation or inpainting.

13. The method of claim 1, further comprising generating, by the computing device, a mesh based on the three-dimensional reconstruction, wherein the mesh represents a surface profile of the wound.

14. The method of claim 13, further comprising determining, by the computing device, a surface area of the wound, wherein determining the surface area of the wound comprises:
computing, by the computing device for each face of the mesh, a cross-product of two component vectors of the face; and
summing, by the computing device, magnitudes of the computed cross-products.

15. The method of claim 13, further comprising determining, by the computing device, a volume of the wound, wherein determining the volume of the wound comprises:
identifying, by the computing device applying a machine-learned model for limb identification, a region of the image that corresponds to a limb associated with the wound;
generating, by the computing device, a combined mask, wherein the combined mask represents regions of the image and the depth map that correspond to either the wound or the limb associated with the wound, and wherein the combined mask is generated based on the identified region of the image that corresponds to the wound and the identified region of the image that corresponds to the limb associated with the wound;
determining, by the computing device by applying the combined mask to the depth map, a first series of depth values and a second series of depth values, wherein the first series of depth values is associated with portions of the depth map corresponding to the wound, and wherein the second series of depth values is associated with portions of the depth map corresponding to the limb associated with the wound;
determining, by the computing device by applying a machine-learned model for inpainting, a revised first series of depth values, wherein the revised first series of depth values corresponds to an inpainting of a portion of the depth map corresponding to the wound using the second series of depth values as a basis, and wherein the revised first series of depth values represents depth values that would result from the wound healing;
calculating, by the computing device for each point within the portion of the depth map corresponding to the wound, a volume of a voxel associated with the point, wherein calculating the volume of the voxel comprises:
calculating, by the computing device, a difference between a respective depth value of the first series of depth values associated with that point and a respective depth value of the revised first series of depth values associated with that point; and
multiplying, by the computing device, the difference by a pixel area, wherein the pixel area corresponds to an area of an infrared-sensitive pixel within a depth sensor used to capture the depth map; and
calculating, by the computing device, wound volume by summing together each of the voxel volumes.

16. The method of claim 15, further comprising:
generating, by the computing device, a three-dimensional reconstruction of the wound healing based on the revised first series of depth values;
applying, by the computing device, one or more colorations to the three-dimensional reconstruction of the wound healing based on one or more colorations in the identified region of the image that corresponds to the limb associated with the wound; and
displaying, by the computing device on a display, the colorized three-dimensional reconstruction of the wound healing.

17. The method of claim 15, further comprising determining, by the computing device, a wound depth, wherein determining the wound depth comprises identifying, by the computing device, a greatest difference from among the differences calculated for each of the points within the portion of the depth map corresponding to the wound.

18. The method of claim 1, further comprising:
providing, by the computing device, the three-dimensional reconstruction of the wound to a user; or
storing, by the computing device, the three-dimensional reconstruction of the wound within a memory such that the three-dimensional reconstruction of the wound is later accessible for analysis.

19. A non-transitory, computer-readable medium having instructions stored thereon, wherein the instructions, when executed by a processor, cause the processor to:
receive an image that includes a wound;
receive a depth map that includes the wound;
identify, by applying a machine-learned model for wound identification, a region of the image that corresponds to the wound;
align the image with the depth map;
determine, based on the identified region of the image that corresponds to the wound, a region of the depth map that corresponds to the wound;
generate a three-dimensional reconstruction of the wound based on the region of the depth map that corresponds to the wound; and
apply one or more colorations to the three-dimensional reconstruction of the wound based on one or more colorations in the identified region of the image that corresponds to the wound.

20. A device comprising:
a camera configured to capture an image;
a depth sensor configured to capture a depth map; and
a computing device configured to:
receive the image, wherein the image includes a wound;
receive the depth map, wherein the depth map includes the wound;
identify, by applying a machine-learned model for wound identification, a region of the image that corresponds to the wound;
align the image with the depth map;
determine, based on the identified region of the image that corresponds to the wound, a region of the depth map that corresponds to the wound;
generate a three-dimensional reconstruction of the wound based on the region of the depth map that corresponds to the wound; and
apply one or more colorations to the three-dimensional reconstruction of the wound based on one or more colorations in the identified region of the image that corresponds to the wound.
